(19) United States
(12) Patent Application Publication
(10) Pub. No.: US 2010/0029336 A1
(43) Pub. Date: Feb. 4, 2010

(54) ELECTRONIC DEVICE WITH TELEPHONE RECEIVER

(75) Inventors: CHING-SEN TSAI, Tu-Cheng (TW); MEI-TSU TSAO, Tu-Cheng (TW); JIA-REN CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/346,817

(22) Filed: Dec. 30, 2008

(30) Foreign Application Priority Data
Jul. 30, 2008 (CN) 200810303203.2

(51) Int. Cl. H04B 1/38; H04M 1/00

(52) U.S. Cl. 455/566; 455/575.1

(57) ABSTRACT

An electronic device includes a display module and a telephone receiver. The display module has a display surface. The telephone receiver has a first sound output surface. A first plane of the display surface intersects with a second plane of the first sound output surface, such that a projecting length of the first sound output surface along the second plane is shorter than a length of the first sound output surface.

### BACKGROUND

1. Technical Field

The present disclosure relates generally to electronic devices and, more particularly, to an electronic device with a telephone receiver.

2. Description of the Related Art

An electronic device such as a mobile phone or a personal digital assistant is widely used in modern society. The electronic device generally has multimedia functions, such as broadcasting movies and playing music. Users want the electronic device to be compact, have a good appearance, and possess multimedia functions. However, the quality of a speaker of the electronic device suffers as the device gets smaller.

Therefore, an electronic device to solve the aforementioned problems is desired.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an exploded, isometric view of a first embodiment of an electronic device, the electronic device including a protecting panel, a front cover, a display module, a telephone receiver, and a back cover.

FIG. 2 is an assembled, cross-sectional view of a part of the electronic device of FIG. 1.

FIG. 3 is an assembled, cross-sectional view of a part of a second embodiment of an electronic device.

### DETAILED DESCRIPTION OF THE EMBODIMENTS

The present disclosure applies to electronic devices in general. However, for the purposes of convenience, embodiments of the electronic device as a mobile phone is described and illustrated.

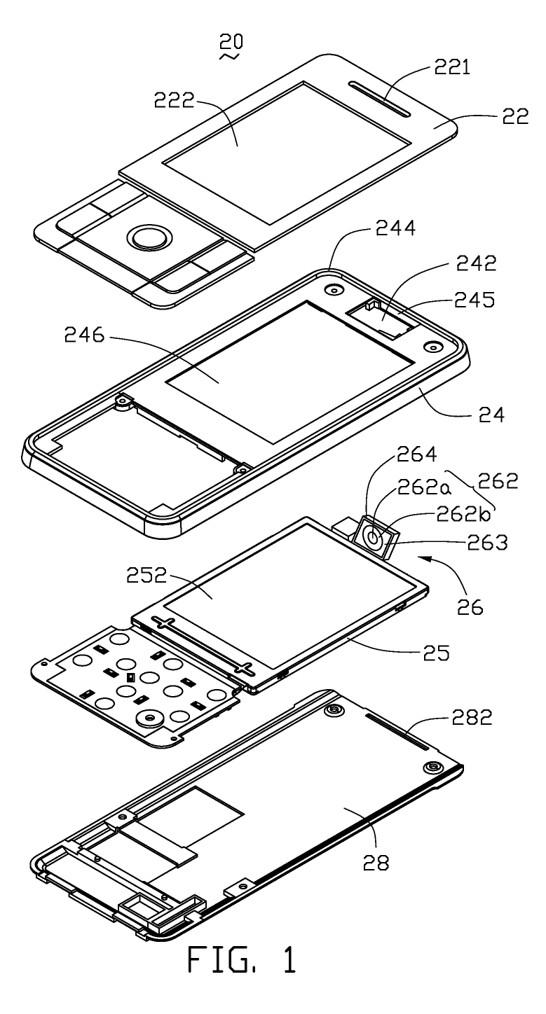

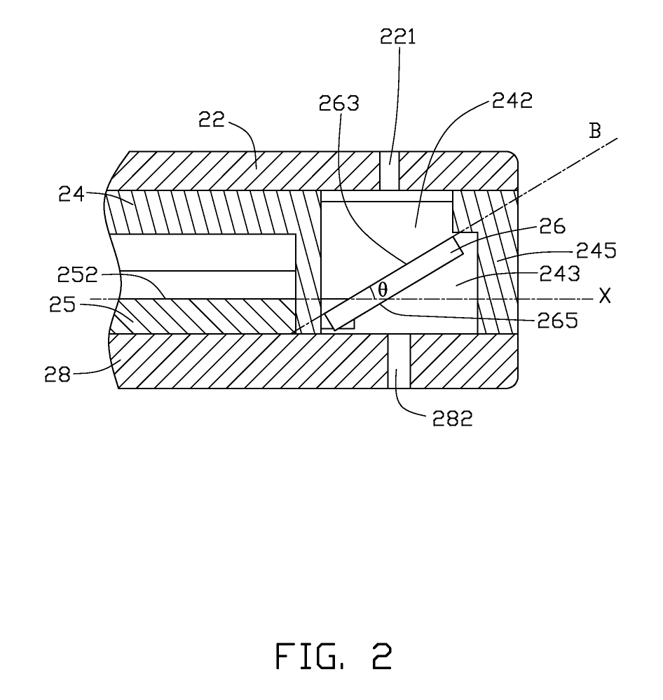

Referring to FIGS. 1 and 2, a first embodiment of an electronic device 20 includes a protecting panel 22, a front cover 24, a display module 25, a telephone receiver 26, and a back cover 28.

In the illustrated embodiment, the protecting panel 22 is a substantially rectangular plate positioned on the front cover 24. The protecting panel 22 is configured for preventing dust from collecting on the display module 25 and the telephone receiver 26. The protecting panel 22 defines a first sound output opening 221 for sound from the telephone receiver 26 to travel through. The protecting panel 22 further defines a first receiving hole 222 to partially receive the display module 25.

The front cover 24 defines a second receiving hole 242 in a first end 245, and a third receiving hole 246 in a middle portion. The second receiving hole 242 is configured for receiving the telephone receiver 26. The third receiving hole 246 is configured for partially receiving the display module 25. A flange 244 is formed on an edge of the front cover 24. The protecting panel 22 is received in a receptacle (not labeled) defined by the flange 244 of the front cover 24. In the illustrated embodiment, the front cover 24 is rectangular shaped, and made of an acrylic resin.

The display module 25 includes a display surface 252 for displaying pictures. A size of the display surface 252 is substantially equal to that of the first receiving hole 222 of the protecting panel 22. The display module 25 is positioned between the front cover 24 and the back cover 28, and substantially parallel to the front cover 24 or the back cover 28.

The telephone receiver 26 includes a speaker 262 and a frame 264 for receiving the speaker 262. The speaker 262 is positioned in a center portion of the frame 264. The telephone receiver 26 further includes a first sound output surface 263. In the illustrated embodiment, the first sound output surface 263 is a side surface of the frame 264 adjacent to the display module 25. In the illustrated embodiment, the speaker 262 includes a first sound output region 262a and a flexible region 262b surrounding the first sound output region 262a. Both the first sound output region 262a and the flexible region 262b are positioned on the first sound output surface 263. A center portion of the first sound output region 262a is aligned with a center portion of the first sound output opening 221. Sound emitted from the speaker 262 first travels through the first sound output surface 263 and then out to the ambient surrounding via the first sound output opening 221. The telephone receiver 26 further includes a second sound output surface 265 opposite to the first sound output surface 263. A second sound output region (not shown) is formed on the second sound output surface 265.

The back cover 28 defines a second sound output opening 282 facing the second sound output region of the telephone receiver 26. A center portion of the second sound output region is aligned with a center portion of the second sound output opening 282. Sound is emitted from the second sound output region out to the ambient surrounding via the second sound output opening 282. In the illustrated embodiment, the back cover 28 is rectangular shaped, and made of an acrylic resin. The back cover 28 and the front cover 24 cooperatively form a cavity 243 for receiving the telephone receiver 26.

Referring to FIG. 2, the telephone receiver 26 is positioned obliquely in the cavity 243. A line B represents a plane of the first sound output surface 263. A line X represents a plane of the display surface 252. The line B intersects with the line X to form an angle θ. In the illustrated embodiment, a range of the angle θ is defined between about 0 degrees and about 90 degrees. It should be understood that, the second sound output opening 282 may be defined in the first end 245 of the front cover 24 facing the second sound output surface 265.

Since the angle θ is defined from about 0 degrees to about 90 degrees, a projecting length of the telephone receiver 26 along the line X is shorter than a length of the telephone receiver 26. Therefore, a length of the cavity 243 receiving the telephone receiver 26 along the line X can be shortened. Thus, the electronic device 20 has a small size.

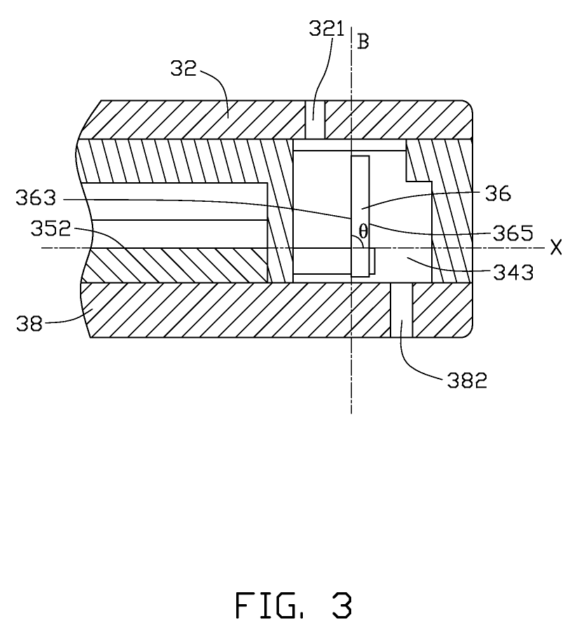

Referring to FIG. 3, a second embodiment of the electronic device 30 is similar to the first embodiment of the electronic device 20, except that a telephone receiver 36 is perpendicularly positioned in a cavity 343, such that an angle θ formed by the line B and the line X is 90 degrees. A protecting panel 32 defines a first sound output opening 321 in a side of the telephone receiver 36 adjacent to a first sound output surface 363. A back cover 38 defines a second sound output opening 382 in a side of the telephone receiver 36 adjacent to a second sound output surface 365. In this case, a project length of the telephone receiver 36 along the line X is at its shortest.

It is believed that the present embodiments and their advantages will be understood from the foregoing description, and it will be apparent that various changes may be made thereto without departing from the spirit and scope of the embodiments or sacrificing all of its material advantages, the examples hereinbefore described merely being preferred or exemplary embodiments.

What is claimed is:

1. An electronic device, comprising:
a display module having a display surface; and
a telephone receiver having a first sound output surface; wherein a plane of the display surface intersects with a plane of the first sound output surface, such that a projecting length of the first sound output surface along the second plane is shorter than a length of the first sound output surface.

2. The electronic device as claimed in claim 1, wherein an angle defined by the display surface and the first sound output surface is about 0 degrees to about 90 degrees.

3. The electronic device as claimed in claim 2, wherein the telephone receiver comprises a speaker and a frame for receiving the speaker; a first sound output region is formed on the first sound output surface of the telephone receiver; the electronic device further comprises a front cover and a protecting panel engaging with the front cover; the protecting panel defines a first sound output opening; a sound from the first sound output region emits to outside via the first sound output opening.

4. The electronic device as claimed in claim 3, wherein a center portion of the first sound output region is aligned with a center portion of the first sound output opening.

5. The electronic device as claimed in claim 3, further comprising a back cover engaging with the front cover to form a cavity for receiving the telephone receiver.

6. The electronic device as claimed in claim 5, wherein the telephone receiver further comprises a second sound output surface opposite to the first sound output surface; a second sound output region is formed on the second sound output surface of the telephone receiver; the back cover defines a second sound output opening; a sound from the second sound output region emits to outside via the second sound output opening.

7. The electronic device as claimed in claim 6, wherein a center portion of the second sound output region is aligned with a center portion of the second sound output opening.

8. The electronic device as claimed in claim 7, wherein an angle formed by the display surface and the first sound output surface is about 90 degrees.

9. The electronic device as claimed in claim 8, wherein the telephone receiver comprises a speaker and a frame for receiving the speaker; a first sound output region is formed on the first sound output surface of the telephone receiver; the electronic device further comprises a front cover and a protecting panel engaging with the front cover; the protecting panel defines a first sound output opening; a sound from the first sound output region emits to outside via the first sound output opening.

10. The electronic device as claimed in claim 9, wherein the telephone receiver further comprises a second sound output surface opposite to the first sound output surface; a second sound output region is formed on the second sound output surface of the telephone receiver; the back cover defines a second sound output opening; a sound from the second sound output region emits to outside via the second sound output opening.

11. The electronic device as claimed in claim 9, wherein the electronic device is a mobile phone.

12. An electronic device, comprising:
a front cover;
a back cover coupled to the front cover;
a display module positioned between the front cover and back cover, and substantially parallel to the front cover or the back cover; and
a telephone receiver positioned between the front cover and back cover, and slanted with respect to the display module, to shorten a total length of the electronic device.

13. The electronic device as claimed in claim 12, wherein the display module has a display surface; the telephone receiver has a first sound output surface; an angle formed by the display surface and the first sound output surface is about 0 degrees to about 90 degrees.

14. The electronic device as claimed in claim 12, wherein the telephone receiver comprises a speaker and a frame for receiving the speaker; a first sound output region is formed on the first sound output surface of the telephone receiver; the electronic device further comprises a protecting panel engaging with the front cover; the protecting panel defines a first sound output opening; a sound from the first sound output region emits to outside via the first sound output opening.

15. The electronic device as claimed in claim 14, wherein a center portion of the first sound output region is align with a center portion of the first sound output opening.

16. The electronic device as claimed in claim 14, wherein the telephone receiver further comprises a second sound output surface opposite to the first sound output surface; a second sound output region is formed on the second sound output surface of the telephone receiver; the back cover defines a second sound output opening; a sound from the second sound output region emits to outside via the second sound output opening.

17. The electronic device as claimed in claim 16, wherein a center portion of the second sound output region is align with a center portion of the second sound output opening.

18. The electronic device as claimed in claim 12, wherein the back cover engages with the front cover to form a cavity for receiving the telephone receiver.
